(19) United States
(12) Patent Application Publication
(10) Pub. No.: US 2009/0295129 A1
(43) Pub. Date: Dec. 3, 2009

(54) FOLDING STROLLER WITH ROLLER ELEMENT-ASSISTED FOLDING

(75) Inventor: Bruno Zweideck, Cholet (FR)

Correspondence Address: BARNES & THORNBURG LLP, 11 SOUTH MERIDIAN, INDIANAPOLIS, IN, 46204, US

(73) Assignee: COSCO MANAGEMENT, INC., Wilmington, DE (US)

(21) Appl. No.: 12/470,326

(22) Filed: May 21, 2009

(30) Foreign Application Priority Data
May 22, 2008 (FR) 0853343

(51) Int. Cl. B62B 7/08

(52) U.S. Cl. 280/642

(57) ABSTRACT

A foldable stroller includes a chassis, a movable push arm, and a connection part interconnecting the chassis and the movable push arm.

This application claims priority under 35 U.S.C. §119(a) to French Patent Application No. FR 0853343, filed May 22, 2008, which is expressly incorporated by reference herein.

### BACKGROUND

The present disclosure relates to a juvenile carrier, and in particular to a juvenile stroller. More particularly, the present disclosure relates to a juvenile stroller having a folding mechanism.

### SUMMARY

A foldable stroller in accordance with the present disclosure includes a chassis and a movable push arm. The chassis comprises a rolling stroller frame. The movable push arm is used by a caregiver to push the rolling stroller frame.

In illustrative embodiments, the connection part. The connection part interconnects the push arm and the rolling stroller frame and cooperates with the push arm and the rolling stroller frame to form a grippable frame mover mounted on the rolling stroller frame. The rolling stroller frame includes a front strut coupled to the connection part in a fixed position and a rear strut coupled to the connection part to pivot relative to the connection part. The movable push arm is coupled to the connection part to slide relative to the connection part between an extended use position and a retracted storage position.

In illustrative embodiments, the foldable stroller further includes external roller-support means for supporting the push arm during sliding movement of the movable push arm relative to the front strut of the rolling stroller frame between the extended use position and the retracted storage position. The roller-support means includes a guide tunnel configured to allow the movable push arm to move through a passageway defined by the guide tunnel.

In illustrative embodiments, the roller-support means further includes an upper set of rolling-bearing elements and a lower set of rolling-bearing elements positioned to lie in spaced-apart relation to the upper set of rolling-bearing elements. The upper set of rolling-bearing elements is arranged around an outer surface of the movable push arm and is configured to provide rolling-bearing support of the push arm within the guide tunnel. The lower set of rolling-bearing elements is arranged around a lower surface of the movable push arm and cooperates with the upper set of rolling-bearing elements to constrain the movable push arm between them for smooth back-and-forth movement of the movable push arm relative to the front strut of the rolling stroller frame.

In illustrative embodiments, movable push arm includes a roller-bearing support and push-arm roller bearing. The roller-bearing support is coupled to a lower end of the movable push arm to move with the movable push arm. The push-arm roller bearing is coupled to the roller-bearing support to move therewith and to provide a rolling point of contact between the lower end of the movable push arm and the front strut so that the movable push arm maintains about a constant spaced-apart position relative to the front strut of the rolling stroller frame during movement of the movable push arm between the retracted storage position and the extended use position.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a side elevation view of a stroller according to the prior art;

FIG. 2 is side elevation view of a foldable stroller in accordance with the present disclosure showing that the stroller has been moved to an unfolded use position and showing that a movable push arm extends upwardly away from a connection part and a rear strut is rotated away from a front strut to provide a stable rolling stroller frame (chassis) for use by child sitting in the stroller;

FIG. 3 is a view similar to FIG. 2 showing the foldable stroller is in a folded storage position and showing that the movable push arm has been lowered with respect to the front strut and the rear strut has rotated about the connection part into confronting relation with the front strut;

FIG. 4 is an enlarged view of the connection piece of FIG. 2 with portions broken away to reveal the connection part includes an upper set of roller-bearing elements, a lower set of roller-bearing elements, and a push-arm roller bearing coupled to the lower end of the movable push arm;

FIG. 5 is a sectional view taken along line 5-5 of FIG. 4 showing the movable push-arm roller bearing is in contact with a lower surface of the front strut;

FIG. 6 is a sectional view taken along line 6-6 of FIG. 5 showing the lower set of roller-bearing elements illustratively includes five roller-bearing elements arranged to support the movable push arm;

FIG. 7 is a sectional view taken along line 7-7 of FIG. 5 showing the upper set of roller-bearing elements illustratively includes six roller-bearing elements arranged to support the movable push arm;

FIG. 8 is a sectional view of another embodiment of a movable push arm showing that the movable push arm has a circular shape and that the movable push arm is supported by a set of three roller-bearing elements;

FIG. 9 is a sectional view of another embodiment of a movable push arm showing that the movable push arm has a triangular shape and that the movable push arm is supported by four roller-bearing elements; and

FIG. 10 is a sectional view of another embodiment of a movable push arm showing that the movable push arm has a square shape and that the movable push arm is supported by four roller-bearing elements.

### DETAILED DESCRIPTION

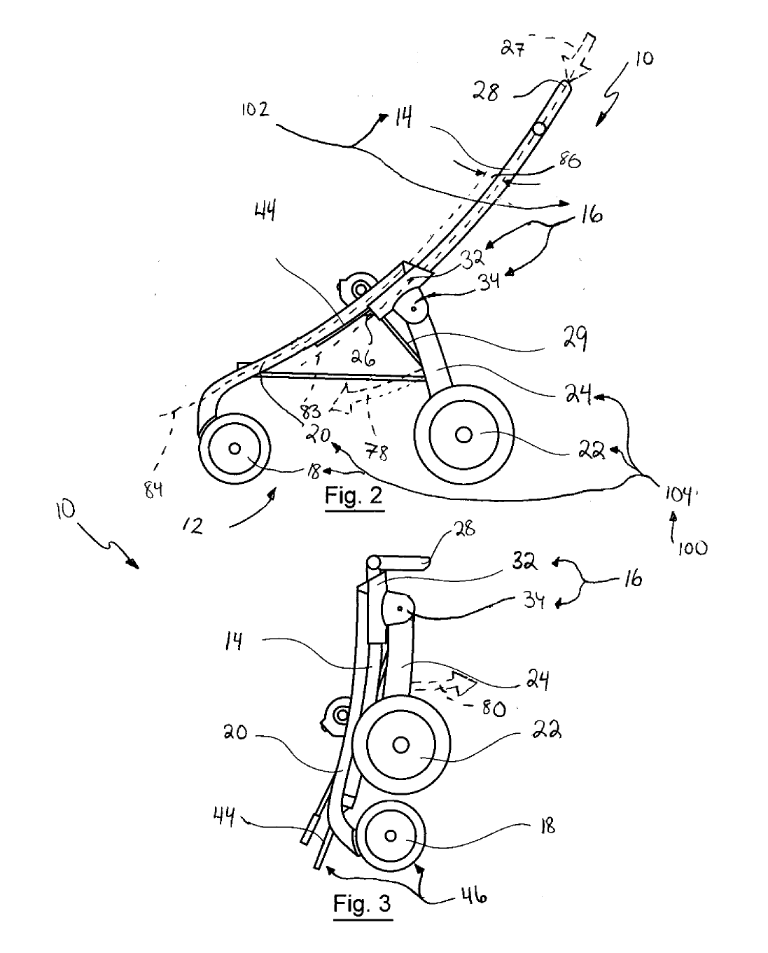

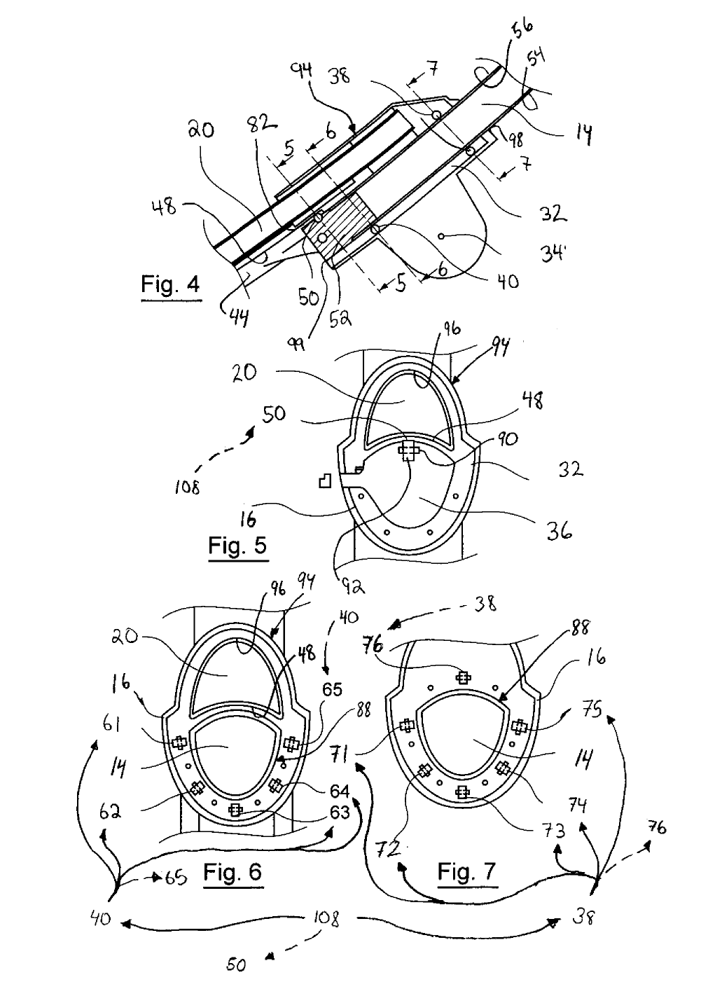

As shown in FIGS. 2 and 3, a foldable stroller 10 includes a rolling stroller frame 100 and a grippable frame mover 102. Illustratively, rolling stroller frame 100 includes a left-frame support 104 as shown in FIG. 2 and an opposite right-frame support (not shown). Left-frame support 104 includes a front wheel 18, a front strut 20, a rear wheel 22, and a rear strut 24. Grippable frame mover 102, as suggested in FIGS. 4-10, is coupled to rolling stroller frame 100 to provide means for a caregiver (not shown) to push rolling stroller frame 100 along the ground.

Illustratively, grippable frame mover 102 includes an arm-support mount 16, a movable push arm 14, and rolling-bearing elements 108 as suggested in FIGS. 4-7. Rolling-bearing elements 108 are coupled to arm-support mount 16 and movable push arm 14. Rolling-bearing elements 108 are configured to provide means for supporting back-and-forth sliding movement of movable push arm 14 relative to arm-support mount 16 between an extended use position shown in FIG. 2 and a retracted storage position shown in FIG. 3. When movable push arm 14 is in the extended use position, movable push arm 14 extends outside of arm-support mount 16. When movable push arm 14 is in the retracted storage position, movable push arm 14 is positioned substantially within arm-support mount 16.

Arm-support mount 16 includes a front-strut mount 94 and is formed to include a tunnel passageway 36. Arm-support mount 16 further includes an upper aperture 98 opening into tunnel passageway 36 and a lower aperture 99 opening into tunnel passageway 36. Illustratively, the lower end of movable push arm 14 is arranged to pass through upper aperture 98 and lower aperture 99 so that movable push arm passes through tunnel passageway 36 as suggested in FIG. 4.

Arm-support mount 16 further includes a front-strut mount 94 formed to include a front-strut mount channel 96 configured to mate with front strut 20 and having a U-shaped cross section. The front-strut mount 94 is further formed to include a strut-contact aperture opening into front-strut mount channel 96. Front strut 20 is arranged to lie within front-strut mount channel 96 and to close the strut-contact aperture as suggested in FIG. 5.

As shown in FIGS. 2 and 3, a foldable stroller 10 includes a chassis 12, a movable push arm 14, and a connection part 16 (arm-support mount). Chassis 12 is adapted to support a child (not shown) sitting in foldable stroller 10. Movable push arm 14 is adapted to transmit force from a caregiver to foldable stroller 10 to cause foldable stroller 10 to move with respect to ground. Connection part 16 interconnects movable push arm 14 and chassis 12 and allows foldable stroller 10 to move between an unfolded-use position shown in FIG. 2 and a folded-storage position shown in FIG. 3.

Chassis 12, as shown in FIGS. 2 and 3, includes a front wheel 18, a front strut 20, a rear wheel 22, and a rear strut 24. Front wheel 18 is coupled to one end of front strut 20 and rear wheel 22 is coupled to one end of rear strut 24. The opposite end of front strut 20 and rear strut 24 are coupled to connection part 16. Rear strut 24 is coupled to connection part 16 to pivot about a pivot axis. When foldable stroller 10 is in the folded-storage position, rear strut 24 has rotated in a clockwise direction (dotted arrow 78) and is positioned to lie in confronting relation with front strut 20 as shown in FIG. 3. When foldable stroller 10 is in the unfolded-use position, rear strut 24 has rotated in a counter-clockwise direction (dotted arrow 80) and is positioned to lie in spaced-apart relation to front strut 20.

Movable push arm 14 includes a lower end 26 and an opposite upper end 28. Upper end 28 is adapted to be grasped by a caregiver during use of foldable stroller 10. When foldable stroller 10 moves from the unfolded-use position to the folded-storage position, movable push arm 14 moves in a downward direction relative to front strut 20 as suggested by dotted arrow 27. To facilitate smooth movement of movable push arm 14, connection part 16 includes multiple features, as suggested in FIGS. 4-7, to reduce the force required to move movable push arm 14.

As shown in FIG. 4, connection part 16 includes a guide tunnel 32 and a hinge 34. Illustratively, the upper end of rear strut 24 is coupled to hinge 34 to pivot about the pivot axis defined by hinge 34. Guide tunnel 32 is formed to include a tunnel passageway 36 through which movable push arm 14 is arranged to pass through during movement between the folded-storage position and the unfolded-use position as suggested in FIG. 4. Guide tunnel 32 includes an upper set of rolling elements 38 or upper group 38 and a lower set of rolling elements 40 or lower group 40 as suggested in FIGS. 4-7. Upper set and lower set of rolling elements 38, 40 cooperate to constrain movable push arm 14 there between during movement between the folded-storage position and the unfolded-use position.

Illustratively, rolling elements of upper and lower set 38, 40 are roller wheels. In other illustrative embodiments, roller elements may be rollers or balls. Roller elements within guide tunnel 32 provide a clearance space 82 as shown in FIG. 4. The various rolling elements guide the movement of movable push arm 14.

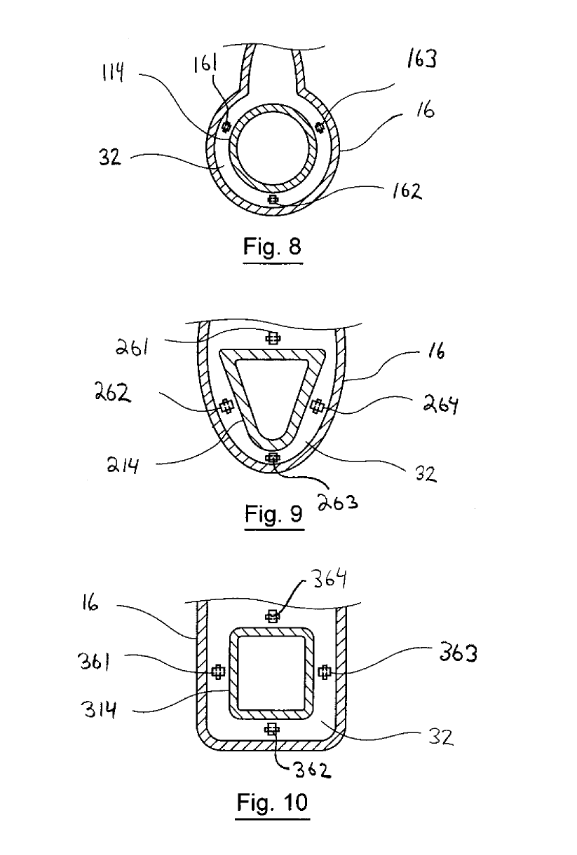

Illustratively, movable push arm 14 has a non-circular cross section 88 as shown in FIGS. 6 and 7. Roller elements further allow the push arm to have various cross-section shapes as shown in FIGS. 8-10. Illustratively, the push-arm cross section may have a circular shape (FIG. 8), a triangular shape (FIG. 9), or a square shape (FIG. 10) or any other suitable shape which works in conjunction with the roller elements. Furthermore, the rolling elements allow for movement of movable push arm 14 even when movable push arm 14 is somewhat twisted.

As shown in FIG. 2, chassis 12 includes front strut 20 and rear strut 24. Front strut 20 includes at its lower end a front wheel 18 or a set of front wheels 18. The opposite end of front strut 20 is coupled to connection part 16. Connection part 16 includes guide tunnel 32 and hinge 34. An upper portion of rear strut 24 is coupled to hinge 34 and a lower portion of rear strut 24 includes a rear wheel 22 or a rear wheel set 22.

As suggested in FIGS. 2 and 3, movable push arm 14 may slide relative to guide tunnel 32 to move from the unfolded-use position of FIG. 2 to the folded-storage position of FIG. 3. A lateral connecting rod 29 interconnects push arm 14 to rear strut 24 to facilitate the movement of rear strut 24 to the folded-storage position as shown in FIG. 3. Illustratively a first end of lateral connecting rod 28 is coupled to a lower end of push arm 14 and an opposite second end of lateral connecting rod 28 is coupled to a mid-portion of rear strut 24 to cause the pivoting movement of rear strut 24 relative to hinge 34.

During movement of movable push arm 14 from the unfolded-use position to the folded-storage position, guide tunnel 32 is configured to provide means for allowing push arm 14 to cooperate with front strut 20 to form a clearance space there between having about a constant distance 86 between front strut 20 and movable push arm 14. Clearance space 82 between push arm 14 and front strut 20 reduces the risk of pinching that may occur in previous designs where the push arm is positioned above the front strut.

As suggested in FIGS. 2 and 3, push arm 14 includes an extension 44 coupled to the lower end of push arm 14. Extension 44 is configured to extend downwardly parallel to front strut 20. When foldable stroller 10 is in the folded-storage position, extension 44 extends beyond front strut 20 and cooperates with front wheels 18 to establish a support foot 46 which allows foldable stroller 10 to assume a standing position as shown in FIG. 3.

As shown in FIG. 4, guide tunnel 32 is configured to provide means for guiding push arm 14 during movement of movable push arm 14 back-and-forth between the unfolded-use position and the folded-storage position. Illustratively, guide tunnel 32 is substantially U-shaped as suggested in FIG. 5, but may be V-shaped as suggested in FIG. 9. Guide tunnel 32 is further defined by a lower surface 48 of front strut 20. As shown in FIG. 4, upper end of front strut 20 is substantially enclosed by connection part 16.

In one illustrative embodiment, guide tunnel 32 has a relatively long length of about 15 to 20 cm. An upper set of roller elements 38 is positioned at an upper end of guide tunnel 32 and a lower set of roller elements 40 is positioned at an opposite lower end of guide tunnel 32 to facilitate sliding movement of a movable push arm as shown in FIG. 2. Movable push arm 14 defines a first curved path 83 and arm-support mount 16 (or connection part) defines a second curved path 84. First curved path 83 and second curved path are arranged to lie at about constant distance 86 from each other as shown in FIG. 2.

Push arm 14 further includes a push-arm roller bearing 50 configured to roll directly on lower surface 48 of front strut 20. Push-arm roller bearing 50 is interconnected to lower end of push arm 14 by an intermediary piece 52 or a roller-bearing support 52 as shown in FIG. 4. In another illustrative embodiment, push-arm roller bearing 50 is coupled directly to the lower end of push arm 14.

As shown in FIG. 5, push-arm roller bearing 50 is in mating contact with lower surface 48 of front strut 20. Push-arm roller bearing 50 is coupled to push arm 14 to move therewith and further operates to maintain the presence of clearance space 82 between push arm 14 and lower surface 48 of front strut 20. Clearance space 82 minimizes friction between push arm 14 and front strut 20 while minimizing the possibility of a pinch point being formed.

As shown in FIG. 6, lower set or rolling elements 40 includes a first lower roller 61, a second lower roller 62, a third lower roller 63, a fourth lower roller 64, and a fifth lower roller 65. Lower rollers 61, 62, 63, 64, and 65 are arranged to lie in confronting relation with a lower push-arm surface 54 and cooperate with push-arm roller bearing 50 to maintain clearance space 82 between push arm 14 and lower surface 48 of front strut 20.

As shown in FIG. 7, upper set of roller elements 38 includes a first upper roller 71, a second upper roller 72, a third upper roller 73, a fourth upper roller 74, a fifth upper roller 75, and a sixth upper roller 76. Upper rollers 71, 72, 73, 74, and 75 are positioned similarly with respect to lower rollers 61, 62, 63, 64, and 65. Upper roller 76 is arranged to engage upper push-arm surface 56 so that when push arm 14 is lifted from below, binding engagement of upper push-arm surface 56 with connection part 16 is minimized.

As shown in FIG. 8, another illustrative embodiment of an upper set of rolling elements 138 includes a first upper roller 161, a second upper roller 162, and a third upper roller 163. Upper rollers 161, 162, and 163 are positioned around a circular push arm 114 to cause clearance space 82 between front strut 20 and circular push arm 114 to be maintained.

Another illustrative embodiment of an upper set of rolling elements 238 is suggested in FIG. 9. Upper set of rolling elements 238 includes a first upper roller 261, a second upper roller 262, a third upper roller 263, and a fourth upper roller 264. Each of the upper rollers 261, 262, 263, and 264 are arranged around the perimeter of a triangular push arm 214 to cause clearance space 82 between triangular push arm 214 and front strut 20 to be maintained.

In another illustrative embodiment, an upper set of rolling elements 338 is suggested in FIG. 10. Upper set of rolling elements 338 includes a first upper roller 361, a second upper roller 362, a third upper roller 363, and a fourth upper roller 364. Each of upper rollers 361, 362, 363, and 364 are arranged around the perimeter of a square push arm 314 to cause clearance space 82 between square push arm 314 and front strut 20 to be maintained. Illustratively, the number of roller elements is related to the shape of the push arm so that a space is maintained between the push arm and the front strut 20.

Upper rollers and lower rollers cooperate with one another to minimize friction between connection part 16 and push aim 14. Upper rollers, lower rollers, and push-arm roller element cooperate to minimize friction between front strut 20 and push arm 14. Including upper and lower rollers within a connection part may be used with various push-arm cross-section shapes, including but not limited to, circles, triangles, and squares. Furthermore, push arm 14 is illustrated as a curved non-circular tube which maximizes the strength and life expectancy of the push arm. Upper and lower rollers permit the use of curved push arm 14 which maximizes the life of the stroller while decreasing maintenance and reducing damage to the various components caused by frictionally engaging one another. Chassis 12 may used with various stroller configurations including a four-wheeled folding stroller and a three-wheeled folding stroller.

As suggested in FIG. 5, a push-arm roller bearing 50 illustratively includes a support shaft 90 and a bearing 92. Support shaft 90 is coupled illustratively to arm-support mount 16. Bearing 92 is coupled to support shaft 90 to rotate about support shaft 90 as shown in FIG. 5.

Numerous stroller frame folding techniques are already known. In general, a compromise is sought between at least some of the following features: efficiency of folding, in which the bulk of the folded stroller must be as small as possible, so as to facilitate its storage and transport, for example in a motor vehicle; simplicity of folding and unfolding, in which the caregiver must be able to perform these actions with a reduced number of steps, and each of these operations must be easy and intuitive for the caregiver; safety of the child transported, and in particular control of the folding (in order to prevent any un-intended folding, in particular when a child is present, and reducing the risks of pinching or other injuries); simplicity and minimized cost of production; and reliability of folding and unfolding, even after a large number of manipulations, and/or when the user does not perform the required operations properly.

A previously known stroller includes the broken fold technique. According to this technique, the push arm or push-arms of the stroller are located, in the unfolded position, substantially as an extension of the legs, or front struts, and the push arms pivot with respect to the latter during folding.

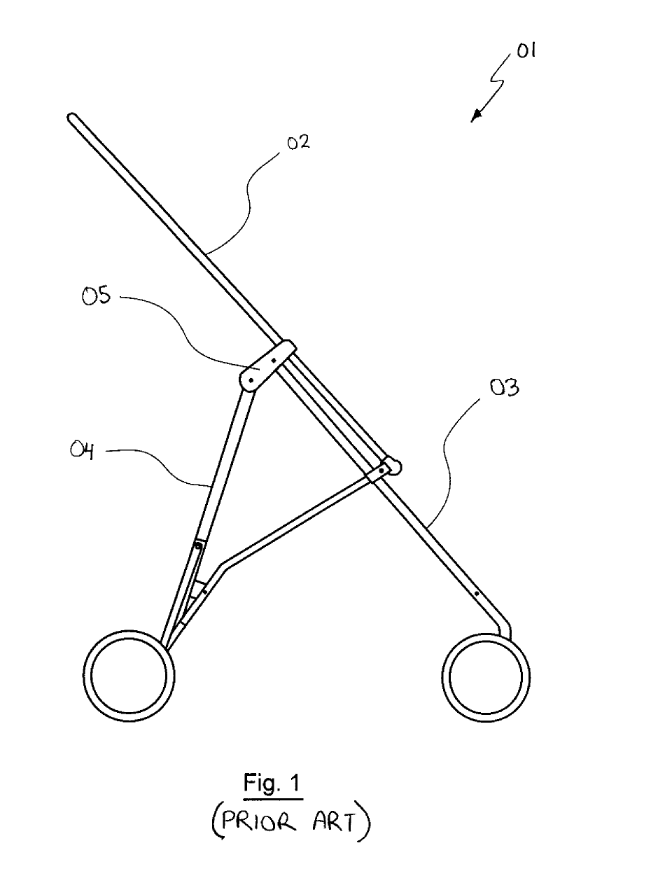

As shown in prior art FIG. 1, another known stroller 01 includes a push arm 02 that can slide parallel to the front strut 03, between a deployed position in which the push arm 02 is substantially an extension of front strut 03 and a folded position wherein the push arm 02 and the front strut 03 are arranged side-by-side relation to one another. Each rear strut 04 is pivotably connected at its upper end to the upper end of the corresponding front strut.

Front strut 03 and push arm 02 are produced in the form of metal tubes, and the sliding of push arm 02 is controlled by a connection part 05, generally made of a plastic material, mounted on front strut 03 and having a slide, spaced-apart from the point of attachment of front strut 03, and in which push arm 02 can slide parallel to front strut 03, while being slightly offset from front strut 03.

The approach of known stroller 01 has disadvantages. First, push arm 02 is guided only over a relatively small portion, corresponding to the length of connection part 05. With the wear of parts, increasing degrees of clearance can appear, and the sliding becomes subject to overhanging phenomena that can make the folding and/or unfolding difficult to perform, and in certain cases cause the frame to become blocked. Blockages may also appear when the caregiver does not move push arm 02 in parallel to connection part 05 causing a twisting of push arm 02 to occur.

Another problem of known stroller 01 is that multidirectional forces due to the deployment of the components, for example, a chassis having complex folding causes significant friction in the guide areas causing an increase in the force necessary to move known stroller 01 from a folded-storage position to an unfolded-use position.

An additional problem of known stroller 01 is that connection part 05 and push arm 02 may be subjected to fouling. Fouling may lead to the blockage phenomena which restricts sliding movement of push arm 02 relative to connection part 05. Because fouling may occur, regular maintenance of connection part 05 and push arm 02 may be required. Maintenance may include lubrication and cleaning of the various components.

Another type of guiding parts, called track/slide guiding, is known. Track/slide guiding does not require a connection part, but instead the push arm includes a track or slide cooperating with a companion track or slide formed in the front strut. Because the track and slide are found over the entire length of the front strut and push arm, wear is reduced. However, the risk of blockage may remain as a foreign body may become lodged in the slide/track. Binding may also occur as the result of a twisting force being applied to the push arms. A known disadvantage to the track/slide guiding technique is that the push arms and front struts must be rectilinear and parallel. This configuration requirement disallows other shapes which may be desired due to a need for compactness, ergonomics, or aesthetics.

Thus, it is desired in the present disclosure is to provide a mechanism which permits simple and effective folding and unfolding. Another desire of the present disclosure is to provide a mechanism less susceptible to wear, soiling, fouling, and mishandling by applying twisting forces to the push arms. A further desire of the present disclosure is to provide a mechanism capable of enabling new stroller shapes and designs. Particularly with regard to the shape of the cross-section of the various chassis elements. Finally, a desire of the present disclosure is to provide a mechanism which minimizes the risk of pinching a child sitting in the stroller.

Illustratively, a foldable stroller 10, in accordance with the present disclosure, includes at least one push arm 14 capable of sliding movement relative to at least one connection part 16 including a guide tunnel 32 through which push arm 14 can pass. One or more of the features discussed previously are intended to be achieved by foldable stroller 10. As suggested in FIG. 4, push arm 14 includes a roller element and guide tunnel 32 including at least one other roller element. Thus, the guiding of push arm 14 with respect to connection part 16 is improved because it is less susceptible to soiling, wear, and mishandling by twisting or non-rectilinear pushing of push arm 14.

Rolling elements of guide tunnel 32 and push arm 14 provide for a space 80 between push arm 14 and front strut 20. The rolling elements allow for improved sliding, and in particular, enable new cross-section shapes to be used in forming chassis 12. In one illustrative embodiment, guide tunnel 32 includes two sets of rolling elements, an upper set of rolling elements 38 and a lower set of rolling elements 40 positioned to lie in spaced-apart relation to upper set of rolling elements 38. The arrangement of the sets of rolling elements 38, 40 enables effective guiding to be obtained using curved struts and curved push arms.

As shown in FIG. 7, upper set of rolling elements 38 includes six rolling elements 71, 72, 73, 74, 75, and 76. As shown in FIG. 6, lower set of rolling elements 40 includes five rolling elements 61, 62, 63, 64, and 65. The rolling elements are distributed to cause a minimum amount of stress to be formed between connection part 16 and push arm 14. Push arm 14 also includes a rolling bearing 50 coupled to a lower end of push arm 14. Rolling bearing 50 allows push arm 14 to move parallel to and under front strut 20. Rolling bearing 50 of push arm 14 is configured to come into contact with front strut 20 of chassis 12 so that the movement of push arm 14 with respect to front strut 20 is guided and controlled.

Push arm 14 may also include, as an optional feature, an extension 44. Extension 44 cooperates with front wheel 18 to form a support foot 46 when foldable stroller 10 is in the folded-storage position as shown in FIG. 3. Support foot 46 allows foldable stroller 10 to assume a standing position when in the folded-storage position.

In another illustrative embodiment, foldable stroller 10 includes a chassis 12 and a movable push arm 14. Chassis includes front strut 20 and rear strut 24. Movable push arm 14 includes an upper end and a lower end. The lower end is positioned to lie opposite the upper end. Foldable stroller 10 further includes external roller-support means 16 for supporting movable push arm 14 for reciprocating sliding movement relative to front strut 20 between a retracted storage position, as shown in FIG. 3, and an extended use position as shown in FIG. 2.

1. A foldable stroller comprising
a rolling stroller frame and
a grippable frame mover coupled to the rolling stroller frame to provide means for a caregiver to push the rolling stroller frame, the grippable frame mover includes an arm-support mount, a movable push arm, and rolling-bearing elements coupled to the arm-support mount and the movable push arm, the rolling-bearing elements are configured to provide means for supporting back-and-forth sliding movement of the movable push arm relative to the arm-support mount between an extended use position extending outside the arm-support mount and a retracted storage position within the arm-support mount.

2. A foldable stroller comprising
a rolling stroller frame including a front strut and a rear strut coupled to the front strut to pivot about a pivot axis relative to the front strut and
a movable push arm including an upper end and a lower end positioned to lie opposite the upper end, and
a connection part coupled to the rolling stroller frame in a fixed position and coupled to the movable push arm to cause the movable push arm to slide back-and-forth relative to the rolling stroller frame between an extended use position wherein the upper end of the movable push arm is positioned to lie a first distance from the connection part and a retracted storage position wherein the upper end of the movable push arm is positioned to lie a relatively smaller second distance from the connection part and the connection part includes an arm-support mount formed to include a tunnel passageway arranged to receive the movable push arm and a set of rolling-bearing elements coupled to the arm-support mount and positioned to lie between the movable push arm and the arm-support mount.

3. The foldable stroller of claim 2, wherein the set of rolling-bearing elements includes an upper group and a lower group positioned to lie in spaced-apart relation to the upper group.

4. The foldable stroller of claim 3, wherein the upper group includes five roller-bearing elements positioned to lie around a perimeter of the movable push arm.

5. The foldable stroller of claim 2, wherein the movable push arm includes a roller-bearing support coupled to the lower end of the movable push arm to move therewith and a push-arm roller bearing coupled to the roller-bearing support.

6. The foldable stroller of claim 5, wherein the movable the movable push arm is located relative to the front strut to cooperate with the front strut to provide means for defining a clearance space there between to reduce friction between the front strut and the movable push arm during movement of the movable push arm between the extended use position and the retracted storage position and to reduce fouling between the movable push arm and the front strut so that binding does not occur.

7. The foldable stroller of claim 6, wherein the push-arm roller bearing is constrained to lie in confronting relation with the front strut to maintain the clearance space between the movable push arm and the front strut.

8. The foldable stroller of claim 2, wherein the movable push arm defines a first curved path, the arm-support mount defines a second curved path, and the first curved path is arranged to lie about a constant distance from the first curved path.

9. The foldable stroller of claim 2, wherein the movable push arm has a non-circular cross section.

10. The foldable stroller of claim 2, wherein the movable push arm further includes an extension coupled to the lower end of the movable push arm, the extension is configured to cooperate with the rear strut to form a support foot in response to the movable push arm assuming the retracted storage position.

11. The foldable stroller of claim 2, wherein each rolling-bearing element includes a support shaft and a bearing coupled to the support shaft to rotate about the support shaft.

12. The foldable stroller of claim 2, wherein the arm-support mount further includes a front-strut mount formed to include a front-strut mount channel configured to mate with the front strut and having a U-shaped cross section, the front-strut mount is further formed to include a strut-contact aperture opening into the front-strut mount channel, and the front strut is arranged to lie within the front-strut mount channel and to close the strut-contact aperture.

13. The foldable stroller of claim 2, wherein the arm-support mount further includes a front-strut mount formed to include a front-strut mount channel configured to mate with the front strut and having a V-shaped cross section, the front-strut mount is further formed to include a strut-contact aperture opening into the front-strut mount channel, and the front strut is arranged to lie within the front-strut mount channel and to close the strut-contact aperture.

14. The foldable stroller of claim 2, wherein the arm-support mount has a length of about 15 to 20 centimetres and the tunnel passageway is aligned along the length of the arm-support mount.

15. The foldable stroller of claim 2, wherein the connection part further includes a hinge coupled to the arm-support mount, the hinge is arranged to extend toward ground away from the arm-support mount, and the rear strut is coupled to the hinge to pivot relative to the hinge.

16. A foldable stroller comprising
a chassis including a front strut and a rear strut coupled to the front strut to pivot relative to the front strut,
a movable push arm including an upper end and a lower end, the lower end is positioned to lie opposite the upper end, and the movable push arm is configured to move relative to the front strut, and
external roller-support means for supporting the movable push arm for reciprocating sliding movement relative to the front strut between a retracted storage position wherein the upper end of the movable push arm is positioned to lie a first distance from the external roller-support means and an extended use position wherein the movable push arm is positioned to lie a relatively larger second distance from the external roller-support means.

17. The foldable stroller of claim 16, wherein the external roller-support means includes an arm-support mount coupled to the front strut in a fixed position and a hinge coupled to the arm-support mount and coupled to the rear strut to cause the rear strut to pivot about a pivot axis defined by the hinge.

18. The foldable stroller of claim 17, wherein the arm-support mount defines a tunnel passageway having an upper aperture opening into the tunnel passageway and a lower aperture opening into the tunnel passageway to cause the movable push arm to pass through the tunnel passageway and the arm-support mount further includes a lower set of rolling elements coupled to the arm-support mount and arranged to lie in confronting relation with the movable push arm.

19. The foldable stroller of claim 18, wherein the arm-support mount further includes an upper set of rolling elements coupled to the arm-support mount and positioned to lie in spaced-apart relation to the lower set of rolling elements.

20. The foldable stroller of claim 16, wherein the movable push arm includes a roller-bearing support coupled to the lower end of the movable push arm to move therewith and a push-arm roller bearing coupled to the roller-bearing support to cause the lower end of the movable push arm to be a fixed distance from the front strut during movement of the movable push arm between the retracted storage position and the extended use position.

21. A foldable stroller comprising
a chassis and
at least one movable push arm capable of sliding with respect to at least one connection part coupled to the chassis, the at least one connection part defining a guide tunnel in which the at least one movable push arm can circulate, characterized in that the guide tunnel comprises at least two sets of rolling-bearing elements, an upper set in an upper portion of the at least one connection part and a lower set in a lower portion of the at least one connection part, wherein each set of rolling-bearing elements comprises at least three rolling-bearing elements.

22. The foldable stroller according to claim 21, characterized in that the upper set includes six rolling-bearing elements and said lower set includes five rolling elements.

23. The foldable stroller according to claim 21, characterized in that the at least one movable push arm has at least one rolling-bearing element in the lower portion.

24. The foldable stroller according to claim 23, characterized in that at least one of the rolling-bearing elements of the at least one movable push arm comes into contact with a front strut of the chassis.

25. The foldable stroller according to claim 21, characterized in that the at least one movable push arm moves parallel to a front strut, and below same.

26. The foldable stroller according to claim 21, characterized in that the guide tunnel and the at least one movable push arm are curved, according to a sliding axis.

27. The foldable stroller according to claim 21, characterized in that a cross-section of the at least one movable push arm is non-circular.

28. The foldable stroller according to claim 21, characterized in that the at least one movable push arm has, at its lower end, an extension forming a support foot when said chassis is folded.

29. The foldable stroller according to claim 21, characterized in that the rolling-bearing elements are roller wheels.

30. The foldable stroller according to claim 21, characterized in that the guide tunnel defines a housing with a substantially V-shaped cross-section, closed by a surface of a front strut.

31. The foldable stroller according to claim 21, characterized in that the guide tunnel defines a housing with a substantially U-shaped cross-section, closed by a surface of a front strut.

32. The foldable stroller according to claim 21, characterized in that the guide tunnel extends over a length of about 15 and 20 cm.

33. The foldable stroller according to claim 21, characterized in that the at least one connection part has a hinge cooperating with a rear strut of the chassis.
